(19) United States
(12) Patent Application Publication
(10) Pub. No.: US 2017/0090985 A1
(43) Pub. Date: Mar. 30, 2017

(54) NON-INVASIVE LIVE REPAIRS AND DEPLOYMENTS

(71) Applicant: Microsoft Technology Licensing, LLC, Redmond, WA (US)

(72) Inventors: Radhey Kiran Shah, Redmond, WA (US); Richard Powell Draves, JR., Seattle, WA (US); Zhou Zhou, Bellevue, WA (US); Jaliya N. Ekanayake, Redmond, WA (US); Eric Boutin, Renton, WA (US)

(21) Appl. No.: 15/162,248

(22) Filed: May 23, 2016

Related U.S. Application Data
(60) Provisional application No. 62/233,963, filed on Sep. 28, 2015.

(51) Int. Cl. G06F 9/50; H04L 12/24; G06F 9/48; H04L 29/08

(52) U.S. Cl. CPC G06F 9/50; H04L 67/10; H04L 41/0816; G06F 9/4843

(57) ABSTRACT

A system that includes a resource monitor and a resource consumer. The resource monitor keeps a state of resources that are available for consumption. For instance, the resources may be processing nodes in a distributed environment. The state of the resources kept by the resource monitor includes an estimated health score along a health score range for each of the resources being monitored. The resource monitor reports the resulting estimated health scores. The resource consumer uses at least some of the reported estimated health scores in order to determine which of the resources to consume. A higher estimated health score for a resource may result in the resource being more readily consumed. A lower estimated health score for a resource may result in consumption of the resource being more likely avoided.

### CROSS-REFERENCE TO RELATED APPLICATION

This application claims the benefit of U.S. Provisional Patent Application Ser. No. 62/233,963 filed Sep. 28, 2015, which provisional patent application is incorporated herein by reference in its entirety.

### BACKGROUND

Computing systems and associated networks have revolutionized the way human beings work, play, and communicate. Nearly every aspect of our lives is affected in some way by computing systems. Computing systems are particularly adept at performing jobs involving large amounts of processing or potentially large amounts of data. When performing a job that involves processing large amounts of data (often referred to simply as “big data”) that itself might be distributed across multiple network nodes, it is often most efficient to divide the job amongst the various network nodes. These divisions of logical work are often referred to as “vertices” in the plural, or a “vertex” in the singular. Not only does this allow for efficiencies of parallelizing, but it also allows for the data that is being processed to be closer to the processing node that is to process that portion of the data.

In order to perform such a distributed job, a job description is provided to a compiler that compiles the job into multiple vertices. A job scheduler then schedules each of the vertices on various network nodes, while honoring dependencies that exist between vertices. A job scheduler will typically be involved with scheduling the vertices of numerous jobs, sometimes from a wide variety of job providers.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to a system that includes a resource monitor and a resource consumer. The resource monitor keeps a state of resources that are available for consumption. For instance, the resources may be processing nodes in a distributed environment. The state of the resources kept by the resource monitor includes an estimated health score along a health score range for each of the resources being monitored. The resource monitor reports the resulting estimated health scores.

The resource consumer uses at least some of the reported estimated health scores in order to determine which of the resources to consume. A higher estimated health score for a resource may result in the resource being more readily consumed. A lower estimated health score for a resource may result in consumption of the resource being more likely avoided. The resource consumption causes the state of the resources themselves to change. Thus, there resource monitor may again report the changed state, causing the resource consumer to change the resources that it consumes in the future. Thus, there is a kind of feedback path that helps the resource consumer choose which resources to consume. For instance, in an example in which the resources are processing nodes in a distributed environment, the resource consumer might be a job scheduler that has the task of scheduling parts (also called vertices) of a job on various network nodes.

In some embodiments, the estimated health score takes into consideration scheduled events, such as repairs, upgrades, or other operations on resources. Accordingly, via its effect on the estimated health score, the resource consumer may avoid consuming resources that are to have scheduled events performed thereon. Thus, there is reduced likelihood of consumption of a resource conflicting with the scheduled event to be performed on the resource. Furthermore, the impact of the performance of the scheduled event on the consumption by the resource consumer may be mitigated. Thus, resources may be consumed in a manner that avoids important scheduled events, thereby leaving resources more available to perform the scheduled events.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates a system that may implement the principles described herein, and which includes a resource monitor that monitors resources and estimates a health score for each resource, and a resource consumer that consumes resources based on the estimated health score;

FIG. 3 illustrates a flowchart of a computerized method for monitoring and consuming computing resources in accordance with the principles described herein;

FIG. 4 illustrates an example system in which a resource monitor may be deployed to gather sufficient information to estimate a health score of a resource; and

FIG. 5 illustrates a context for operation of the cluster repair manager.

### DETAILED DESCRIPTION

At least some embodiments described herein relate to a system that includes a resource monitor and a resource consumer. The resource monitor keeps a state of resources that are available for consumption. For instance, the resources may be processing nodes in a distributed environment. The state of the resources kept by the resource monitor includes an estimated health score along a health score range for each of the resources being monitored. The resource monitor reports the resulting estimated health scores.

The resource consumer uses at least some of the reported estimated health scores in order to determine which of the resources to consume. A higher estimated health score for a resource may result in the resource being more readily consumed. A lower estimated health score for a resource may result in consumption of the resource being more likely avoided. The resource consumption causes the state of the resources themselves to change. Thus, there resource monitor may again report the changed state, causing the resource consumer to change the resources that it consumes in the future. Thus, there is a kind of feedback path that helps the resource consumer choose which resources to consume. For instance, in an example in which the resources are processing nodes in a distributed environment, the resource consumer might be a job scheduler that has the task of scheduling parts (also called vertices) of a job on various network nodes.

In some embodiments, the estimated health score takes into consideration scheduled events, such as repairs, upgrades, or other operations on resources. Accordingly, via its effect on the estimated health score, the resource consumer may avoid consuming resources that are to have scheduled events performed thereon. Thus, there is reduced likelihood of consumption of a resource conflicting with the scheduled event to be performed on the resource. Furthermore, the impact of the performance of the scheduled event on the consumption by the resource consumer may be mitigated. Thus, resources may be consumed in a manner that avoids important scheduled events, thereby leaving resources more available to perform the scheduled events.

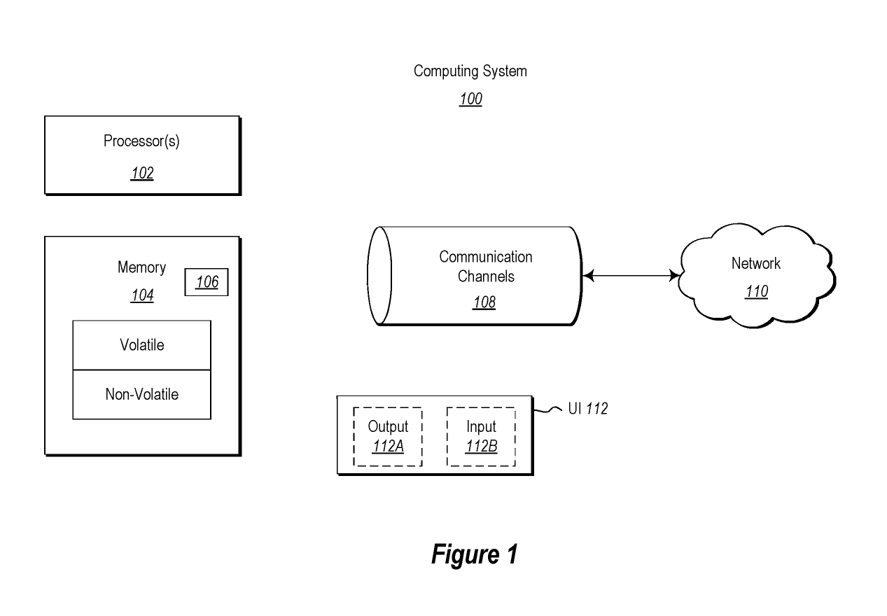

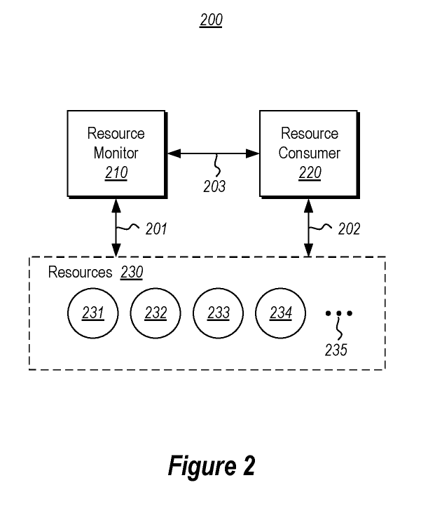

Some introductory discussion of a computing system will be described with respect to FIG. 1. Then, the structure and operation of the resource monitor and resource consumer will be described with respect to FIGS. 2 through 5.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “monitor”, “scheduler”, “manager”, “module”, “compiler”, or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computerexecutable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, projectors, tactile output, valves, actuators, holograms and so forth. Examples of input mechanisms 112B might include, for instance, microphones, touchscreens, holograms, cameras, keyboards, accelerometers, levers, pedals, buttons, knobs, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

FIG. 2 illustrates a system 200 that may implement the principles described herein. The system 200 includes a resource monitor 210 and a resource consumer 220. The resource monitor 210 monitors resources 230 as represented by arrow 201. The resource consumer consumes the monitored resources 230 as represented by arrow 202. The resource monitor 210 may be structured as described above for the executable component 106 of FIG. 1. Also, the resource consumer 220 may be structured as described above for the executable component 106 of FIG. 1.

In the illustrated embodiment, the resources being monitored and consumed are illustrated as resources 230. The principles described herein apply regardless of the type or number of resources 230. However, for illustration and example purposes only, the resources 230 are each represented as circles and include four resources 231 through 234, though the ellipses 235 represent that the principles described herein apply regardless of the number or type of such resources. In one embodiment referred to hereinafter as the “job scheduler embodiment”, the resources 230 are each processing nodes in a distributed network, and the resource consumer 220 is a job scheduler that schedules tasks (e.g., vertices of a distributed job) on the processing nodes.

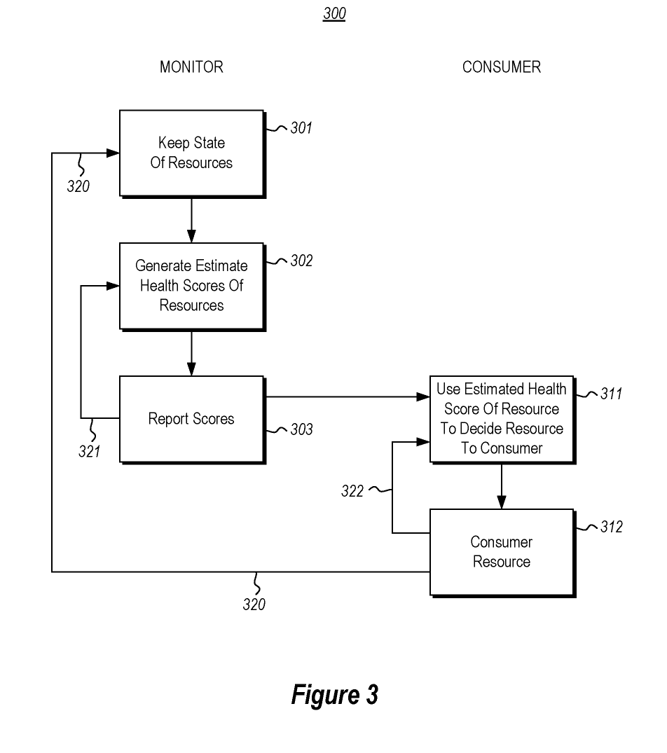

FIG. 3 illustrates a flowchart of a computerized method 300 for monitoring and consuming computing resources in accordance with the principles described herein. Some of the acts of the method 300 are performed by a resource monitor (e.g., the resource monitor 210 of FIG. 2) as represented in the left column of FIG. 3 under the heading “Monitor”. Others of the acts of the method 300 are performed by a resource consumer (e.g., the resource consumer 220 of FIG. 2) as represented in the right column of FIG. 3 under the heading “Consumer”.

In accordance with the method 300, a resource monitor keeps a state of resources in the form of an estimated health score along a health score range for each of multiple resources (act 301). This estimated health score range is generated by the resource monitor (act 302) based on other state of the resource. Furthermore, the resource monitor reports the of estimated health scores (act 303). In FIG. 2, this reporting is represented by arrow 203. The status of one or more or all of the resources being monitored (and thus a resulting estimated health score) may change over time. Accordingly, as represented by arrow 321, the resource monitor may repeatedly generate and report the estimated health scores so that the resource consumer has an up-to-date understanding of the respective estimated health score of the resources.

The estimated health score may actually be a prediction of a health score that the resource will have in the future if consumed by the resource consumer. The estimated health score for a particular resource may use any information useful in estimating the current or imminent health of the particular resource. As examples only, the estimated health score may be based on an audit history of the particular resource, a reachability of the particular resource, and/or a maintenance plan of the particular resource.

The resource consumer uses at least some of the reported health scores in order to determine (act 311) which of the resources to consume, and also potentially how much of any selected resource to consume. For instance, in the job scheduler embodiment, the resource consumer is a job scheduler that determines which processing node to run vertices of a job on. The resource consumer then consumes the selected resource (act 312).

This consumption causes the state of resource monitored by the resource monitor to change. This change, as represented by feedback line 320, either directly results in, or is eventually detected by, a subsequent monitoring of the state of the resources (act 301). For instance, if a vertex is run on a processing node, that processing node may no longer be available in the short term for running other vertices of the job. As represented by the arrow 322, the resource consumer may repeatedly use at least some of the potentially dynamically changing reported estimated health scores to determined which (or how much) of a resource to consume.

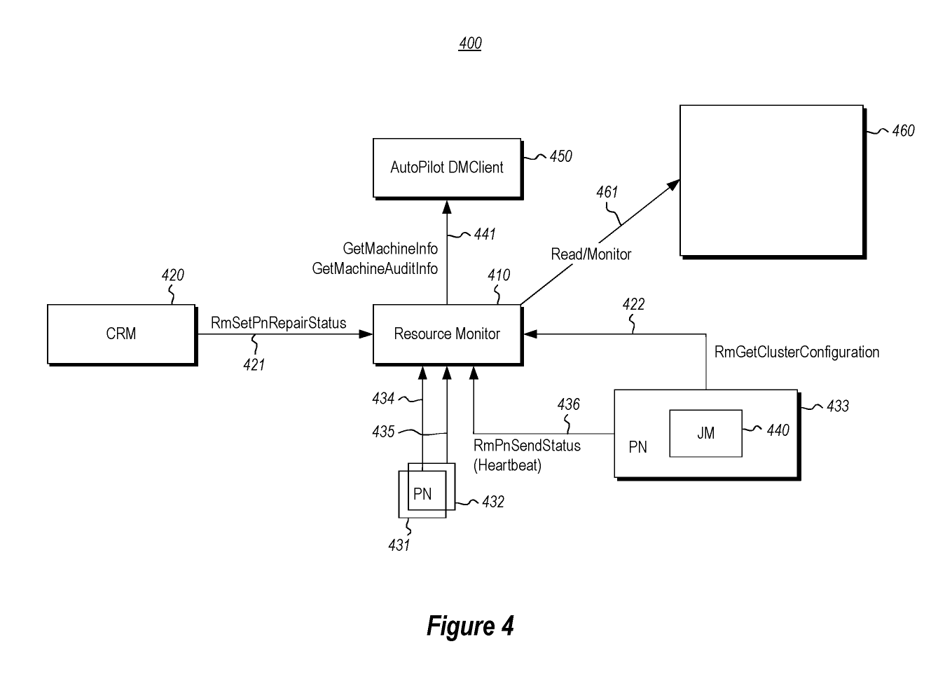

FIG. 4 illustrates an example system 400 in which a resource monitor 410 may be deployed to gather sufficient information to estimate a health score of a resource. For instance, the resource monitor 410 may be the resource monitor 210 of FIG. 2 in the context of a job scheduler embodiment though the job scheduler itself is not shown in FIG. 4.

The environment of FIG. 4 may be thought of as an “autopilot” environment. When repairs or deployments are scheduled on a processing node, or as a processing node's health deteriorates, or as the processing node is predicted to fail in performing a particular computation, then the processing node may automatically be taken as not available in the cluster of machines from which a job scheduler may schedule particular jobs. Likewise, after repair or deployment on a processing node, the processing node automatically re-integrates with the cluster.

The central component in FIG. 4 is a resource monitor 410. The resource monitor 410 communicates with its various surrounding components and determines the health of each processing node (labelled as PN in FIG. 4). The resource monitor 410 and the surrounding components may be structured as described above for the executable component 106 of FIG. 1. The term “processing node” or “process node” is a term commonly used in cloud computing. Indeed, FIG. 2 may be implemented in a cloud computing environment with the various processing nodes PN representing actual processing nodes of a cloud computing environment. However, the processing nodes PN may alternatively be computational resources (e.g., computing systems) that are in any distributed environment.

The cluster repair module 420 reports (as represented by arrow 421) data (represented as RmSetPnRepairStatus) that lists machines (e.g., processing nodes) that are in ask mode due to imminent maintenance or for some other reason. The names of the interfaces used by the resource monitor 410 to communicate with surrounding components are not important. For instance, imminent maintenance may include an operating system upgrade, a service upgrade, a hardware upgrade, soft reboot, hard reboot, or the like.

The cluster repair module 420 ensures that machines undergoing such system repairs and interfering code deployments do not get new jobs scheduled on them. The cluster repair module 420 also delays repairs on a processing node if there are running containers on that processing node, until all containers have completed on that processing node.

Processing nodes that are in ask mode are asked if they can take on assignment of a vertex prior to assignment of a vertex. The processing node may report more details regarding the timing and extent of its maintenance. The processing node may be in “drain mode” in which case it is completing its existing tasks, but not taking new tasks. In any case, the presents of a potentially conflicting maintenance schedule could affect the estimated health score for that resource.

The system is illustrated as including three processing nodes 431, 432 and 433, which are the resources being monitored in this job scheduler embodiment. On each of at least some of the processing nodes PN, there is an auxiliary service that sends a periodic signal to the resource manager 410 giving information about currently running processes on the processing node PN, and other information about the processing node. For instance, in FIG. 4, each processing node sends a heartbeat signal 434, 435 and 436, respectively. For instance, the processing node 433 is illustrated sending (as represented by arrow 436) data (represented as RmPnSendStatus) representing that the processing node 433 is operating and running a certain number of processes. If the signal is not received as expected by the resource monitor 410, then the resource monitor 410 detects that the resource is having a problem related to reachability. If the signal is received, then the resource monitor 410 can use the fact that the resource is reachable and the number of processes already running on the resource, in order to determine the estimated health of that resource.

A job manager 440 (labelled as JM) uses the health information gathered by the resource monitor 410 to determine the list of possible nodes to start containers on. The container is simply an environment in which a task may be run. To ensure security isolation, the container might be a virtual machine. The resource monitor 410 may also put machines in a “blacklist”, meaning that the job manager is not to run containers on such blacklisted machines. This is a useful technique if an interface determines a machine is bad, or some maintenance needs to be done on few machines.

The resource monitor 410 may issue a command (as represented by arrow 441 and in this example called “GetMachineInfo”) from an autopilot component 450. The autopilot component 450 is a component that observes behavior of each of the resources. The resource monitor 410 may thus use this command to get the observed behaviors. The resource monitor 410 may also get the history of observed behaviors on each machine using the GetMachineAuditInfo command. For instance, the resource monitor 410 may learn that a particular processing node has not encountered any problems for the last two hours, or had a transient disk failure one hour ago. These factors may also affect the estimated health score for the resource.

The files 460 on the local machine can be ways for us to exclude machines from health calculations. The resource monitor 410 reads (as represented by arrow 461) the list of machines in the cluster as well as the list of virtual networks from a local machine. The files 460 include a variety of files that may be readable by the resource monitor 410 in an efficient way (e.g., from a local machine or from the same machine as is running the resource monitor 410). From the list of machines in the cluster, and the list of virtual network of the cluster, the resource monitor 410 builds a devices list (wherein the device name is the processing node name). The resource monitor 410 monitors changes in the files 460 for following information: a list of blacklisted processing node that are not available for a job manager 440 to schedule computational tasks on, configurations specific to the resource monitor 410, and cluster-wide configurations.

The resource monitor 410 gets all of the above information, estimates the health for each machine based on some or all of the above information, and determines a status of the machine. The resource monitor 410 may represent the health of the machine as an attribute. The attribute may, for instance, have values from zero to one, where one is the best health status, and zero is the worst health status. The status of the machine may be represented by an attribute also, which may be called, for instance, “RmDeviceStatus”. A “Usable” value from the attribute “RmDeviceStatus” indicates that the machine is usable by a job manager. An “Askmode” status means that the machine is scheduled for repair. In some case, such machines may still be usable, but only upon inquiry from the cluster repair monitor module 420 and/or the resource monitor 410. A “Failed” status indicates that the machine has recently failed. A “blacklisted” status indicates that the machine is not to be used.

The job manager 440 may be an application master that runs jobs (e.g., a job scheduler). It periodically calls (as represented by arrow 442) the resource monitor 410, and obtains the health information for all machines in the environment. This call is represented as “RmGetClusterConfiguration” in FIG. 4. This health information is used in job managers scheduling logic to determine the best machine to start a container for performing a task of the job.

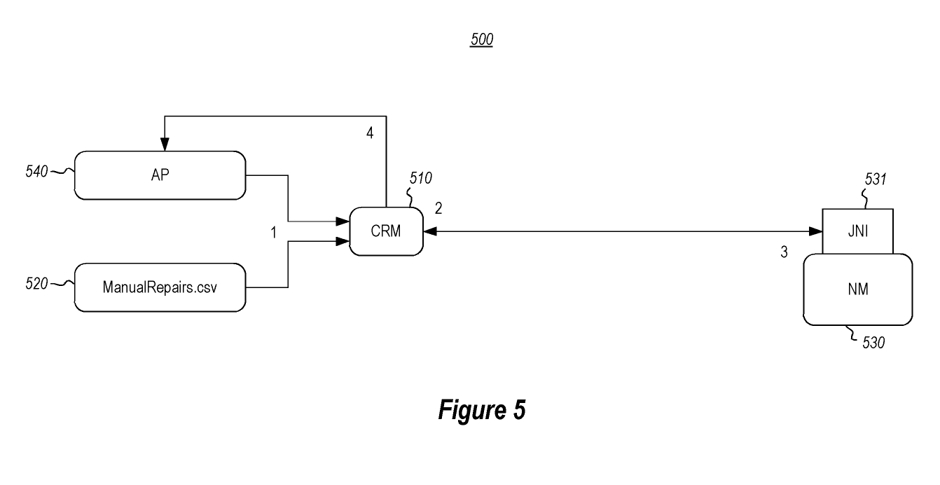

FIG. 5 illustrates a context 500 for operation of the cluster repair manager 510, which is an example of the cluster repair module 420 of FIG. 4. The cluster repair manager 510 receives deployment/upgrades from one of the local files 520 called hereinafter ManualRepairs.csv. The local file 520 is an example of one of the local files 460 of FIG. 4.

The cluster repair manager 510 processes the repairs for each machine. If a repair is an interfering rollout, it calls the node manager Java Network Interface JNI interface 531 on the node manager 530 to set the node manager NM to maintenanceMode =ON for a certain amount of time. An “interfering rollout” is a repair that will interfere with the operation of a processing node (such as an operating system upgrade, a BIOS upgrade, a soft reboot, a hard reboot, a service restart, a wipe of memory, or the like).

The NM JNI interface 531 then returns the number of running containers on the node. If the number of running containers is zero, the cluster repair monitor module 510 will contact the auditing module 540 (an example of the component 450 of FIG. 4) to start the repair action immediately. Otherwise, the cluster repair monitor module 510 will contact the auditing module 540 to delay the repair by the DelayUnit parameter in a local file 460.

Accordingly, the principles described herein provide an efficient mechanism for consuming resources by careful monitoring of a variety of behaviors of the resources to come up with an estimated health score. Scheduled maintenance of the resource may also be taken into consideration so as to avoid resource consumption that would conflict with the scheduled maintenance on that resource.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a resource monitor that keeps a state of resources in the form of an estimated health score along a health score range for each of a plurality of the resources, and reports the plurality of estimated health scores; and
a resource consumer uses at least some of the reported plurality of estimated health scores in order to determine which of the resources to consume, the consumption causing the state of resources monitored by the resource monitor to change.

2. The system in accordance with claim 1, the causing of the state of resources monitored by the resource monitor to change further causing a change in the estimated health score for at least one of the plurality of resources.

3. The system in accordance with claim 1, the estimated health score being a prediction of a health score that the resource will have in the future if consumed by the resource consumer.

4. The system in accordance with claim 1, further comprising:
the plurality of resources.

5. The system in accordance with claim 1, the plurality of resources comprising a plurality of processing nodes in a distributed network.

6. The system in accordance with claim 5, the resource consumer being a scheduler that schedules tasks on at least some of the plurality of processing nodes.

7. The system in accordance with claim 1, the estimated health score for at least a particular resource being based on an audit history of the particular resource.

8. The system in accordance with claim 1, the estimated health score for at least a particular resource being based on a reachability of the particular resource.

9. The system in accordance with claim 1, the estimated health score for at least a particular resource being based on a maintenance plan of the particular resource.

10. The system in accordance with claim 1, the resource consumer also using at least one of the reported plurality of estimated health scores to determine how much of a resource to consume.

11. A computerized method for monitoring and consuming computing resources, the method comprising:
an act of a resource monitor keeping a state of resources in the form of an estimated health score along a health score range for each of a plurality of the resources, and reporting the plurality of estimated health scores; and
an act of a resource consumer using at least some of the reported plurality of health scores in order to determine which of the resources to consume, the consumption causing the state of resources monitored by the resource monitor to change.

12. The method in accordance with claim 11, the state of the resources including the estimated health score changing over time.

13. The method in accordance with claim 12, the act of the resource monitor reporting the plurality of health scores being repeatedly performed.

14. The method in accordance with claim 13, the act of the resource consumer using the at least some of the reported plurality of health scores in order to determine which of the resources to consume being repeatedly performed.

15. The method in accordance with claim 11, the act of the resource consumer using the at least some of the reported plurality of health scores in order to determine which of the resources to consume being repeatedly performed.

16. The method in accordance with claim 11, the estimated health score for a particular consumer being a prediction of a health score that the resource will have in the future if consumed by the resource consumer.

17. The method in accordance with claim 11, the plurality of resources comprising a plurality of processing nodes in a distributed network.

18. The system in accordance with claim 17, the resource consumer being a scheduler that schedules tasks on at least some of the plurality of processing nodes.

19. The method in accordance with claim 11, the resource consumer also using at least one of the reported plurality of estimated health scores to determine how much of a resource to consume.

20. A computer program product comprising one or more computer-readable store media having instructions thereon that are structured such that, when executed by one or more processors of the computing system, cause the computing system to perform a method for monitoring and consuming computing resources, the method comprising:
an act of a resource monitor keeping a state of resources in the form of an estimated health score along a health score range for each of a plurality of the resources, and reporting the plurality of estimated health scores; and
an act of a resource consumer using at least some of the reported plurality of health scores in order to determine which of the resources to consume, the consumption causing the state of resources monitored by the resource monitor to change.
